(19) United States
(12) Patent Application Publication
(10) Pub. No.: US 2012/0064762 A1
(43) Pub. Date: Mar. 15, 2012

(54) TERMINAL STRUCTURE OF COAXIAL CABLE, CONNECTOR, AND SUBSTRATE UNIT

(75) Inventors: Hiroyuki MUROI, Kawasaki (JP); Kazuji ABE, Kawasaki (JP)

(73) Assignee: FUJITSU LIMITED, Kawasaki-shi (JP)

(21) Appl. No.: 13/218,534

(22) Filed: Aug. 26, 2011

(30) Foreign Application Priority Data
Sep. 14, 2010 (JP) 2010-205530

(51) Int. Cl. H01R 9/05; H01B 11/06

(52) U.S. Cl. 439/578; 174/34

(57) ABSTRACT

A terminal structure of coaxial cable includes a substrate, a coaxial cable, and a conductive shield member. The substrate includes a ground potential layer therein and a ground electrode thereon which is electrically connected to the ground potential layer through a via. The coaxial cable includes a conductor core, a dielectric body surrounding the conductor core, an external conductor layer surrounding the dielectric body, and an outer coat layer surrounding the external conductor layer. The dielectric body has a first protrusion portion configured to protrude from an end of the external conductor layer. The conductor core has a second protrusion portion configured to protrude from an end of the dielectric body. The second protrusion portion is electrically connected to the substrate. The conductive shield member covers the first protrusion portion and the second protrusion portion, and is connected to the ground electrode.

### CROSS-REFERENCE TO RELATED APPLICATION

This application is based upon and claims the benefit of priority of Japanese Patent Application No. 2010-205530, filed on Sep. 14, 2010, the entire contents of which are incorporated herein by reference.

### FIELD

The embodiments discussed herein relate to a terminal structure of coaxial cable, a connector, and a substrate unit.

### BACKGROUND

For example, when a high frequency signal of 1 GHz or more is transmitted using a coaxial cable, the high frequency signal is transmitted from the coaxial cable to a signal line on a circuit board via a connector connecting the coaxial cable with the circuit board. If impedances are not matched in a transmission path of the high frequency signal, such as input/output of driver/receiver, a pattern of circuit board, a connector, a cable, and a terminal processing portion of the cable, the transmission signal is reflected in a portion where impedances are not matched, and waveform distortion occurs. Therefore, it is preferred that the impedances are matched in the transmission path of the high frequency signal.

Generally, a coaxial cable includes a conductor core, a dielectric body surrounding the conductor core, a conductor layer surrounding the dielectric body, and a protective layer surrounding the conductor layer. To electrically connect the conductor core of the coaxial cable with a pattern of the circuit board, at the end portion of the coaxial cable, an outer coat (sheath) is removed and an external conductor layer is exposed. Further, the external conductor layer is removed, and the dielectric body is exposed. Furthermore, the dielectric body is removed, and the conductor core is exposed (protrudes from an end of the dielectric body).

The impedance of the coaxial cable is determined by the inductance and the capacitance per unit length of the cable. Therefore, the impedances are different between a portion in which the conductor core and the dielectric are exposed and a portion in which the conductor core and the dielectric are covered by the external conductor layer (shield layer).

JP-A-2007-19232 discloses a terminal structure of coaxial cable in which a shield member is arranged to cover the dielectric exposed by removing the conductor layer.

However, the conductor core is exposed in a portion in which the dielectric body is removed, so the impedances are not matched between a portion in which the conductor core is exposed and a portion in which the conductor core is covered by the external conductor layer (shield layer).

### SUMMARY

According to an embodiment of the invention, a terminal structure of coaxial cable includes a substrate, a coaxial cable, and a conductive shield member. The substrate includes a ground potential layer therein and a ground electrode thereon which is electrically connected to the ground potential layer through a via. The coaxial cable includes a conductor core, a dielectric body surrounding the conductor core, an external conductor layer surrounding the dielectric body, and an outer coat layer surrounding the external conductor layer. The dielectric body has a first protrusion portion configured to protrude from an end of the external conductor layer. The conductor core has a second protrusion portion configured to protrude from an end of the dielectric body. The second protrusion portion is electrically connected to the substrate. The conductive shield member covers the first protrusion portion and the second protrusion portion, and is connected to the ground electrode

The objects and advantages of embodiments of the invention will be realized and attained at least by the elements, features, and combinations particularly pointed out in the claims. It is to be understood that both the foregoing general description and the following detailed description are exemplary and explanatory, and are not restrictive of the invention.

### BRIEF DESCRIPTION OF DRAWINGS

FIG. 1 is a perspective view showing an example of a substrate unit according to a first embodiment.

FIG. 2 is a plan view showing an example of a coaxial cable according to the first embodiment.

FIG. 3A is a cross-sectional view taken along line IIIA-IIIA in FIG. 2. FIG. 3B is a cross-sectional view taken along line IIIB-IIIB in FIG. 2. FIG. 3C is a cross-sectional view taken along line IIIC-IIIC in FIG. 2.

FIG. 4 is a plan view showing an example of a substrate according to the first embodiment.

FIG. 5 is a cross-sectional view taken along line V-V in FIG. 4.

FIG. 6 is a perspective view showing an example of a shield member according to the first embodiment.

FIG. 7 is a cross-sectional view taken along a direction in which a conductor core extends in FIG. 1 according to the first embodiment.

FIG. 8 is a cross-sectional view taken along a direction in which a conductor core extends in FIG. 1 according to a second embodiment.

FIG. 9 is a cross-sectional view taken along a direction in which a conductor core extends in FIG. 1 according to a third embodiment.

FIG. 10 is a perspective view showing an example of a connector according to a fourth embodiment.

### DESCRIPTION OF EMBODIMENTS

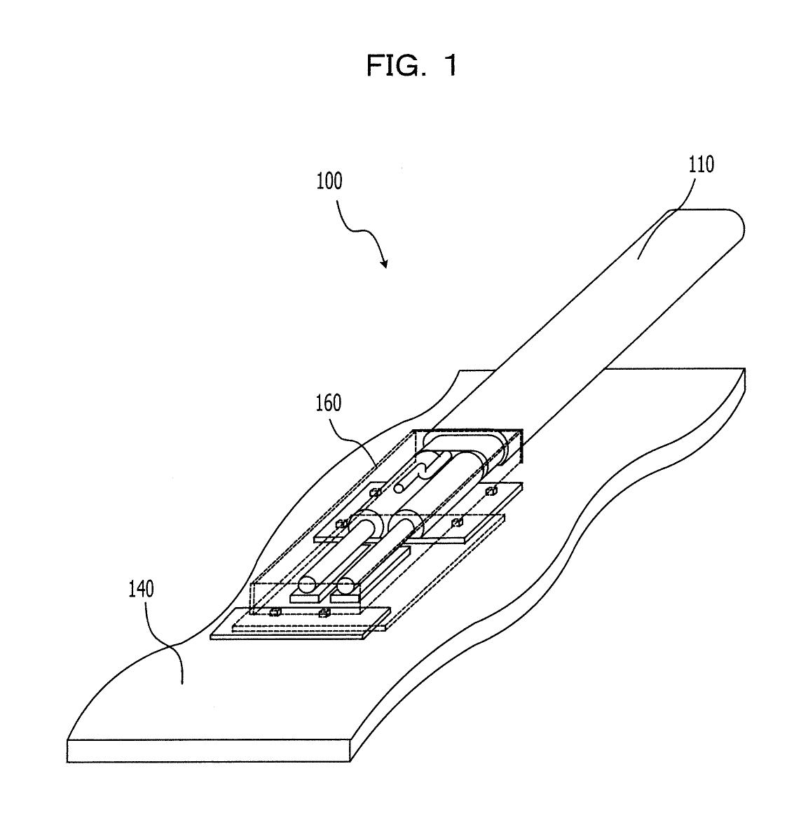

A substrate unit 100 of a first embodiment will be described with reference to FIG. 1. FIG. 1 is a perspective view showing an example of the substrate unit 100 of the present embodiment. As shown in FIG. 1, the substrate unit 100 of the present embodiment can include a coaxial cable 110, a substrate 140, and a shield member 160. Hereinafter, the configuration of each component will be described in detail.

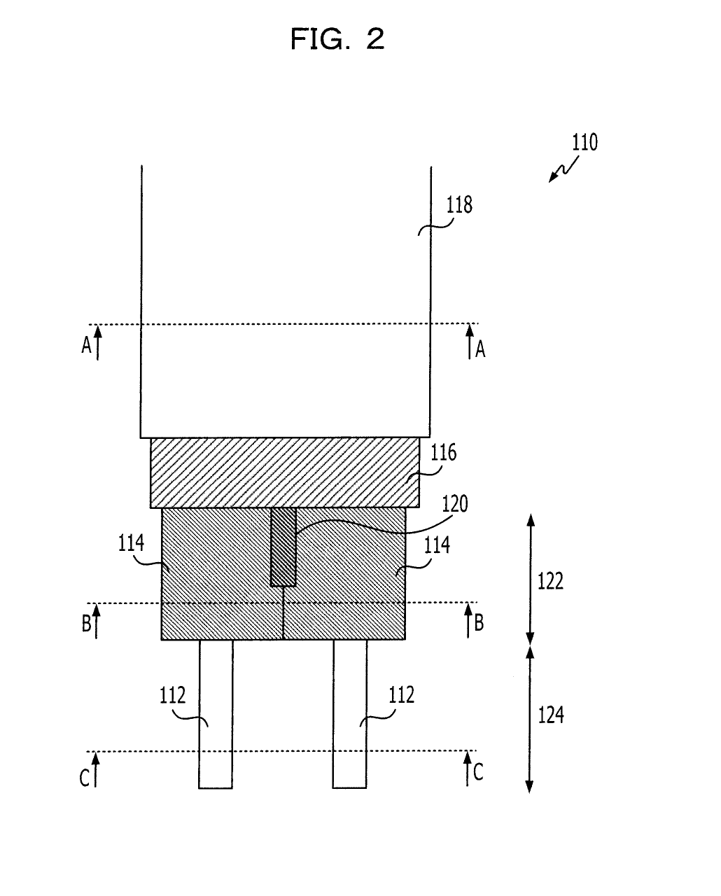

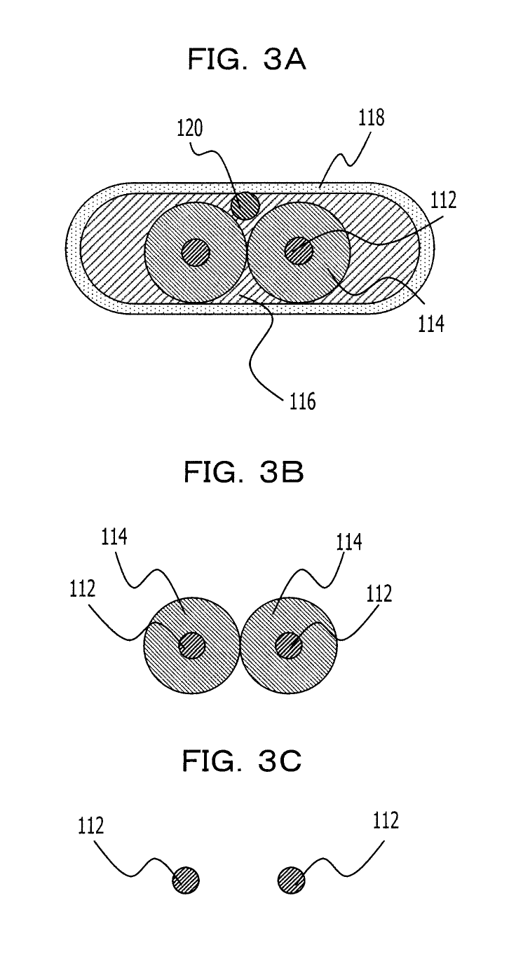

First, the coaxial cable 110 of the present embodiment will be described with reference to FIGS. 2 and 3. FIG. 2 is a plan view showing an example of the coaxial cable 110 of the present embodiment. The coaxial cable 110 of the present embodiment can be a two-core coaxial cable. FIG. 3A is a cross-sectional view taken along line IIIA-IIIA in FIG. 2. FIG. 3B is a cross-sectional view taken along line IIIB-IIIB in FIG. 2. FIG. 3C is a cross-sectional view taken along line IIIC-IIIC in FIG. 2.

As shown in FIG. 2, the coaxial cable 110 includes conductor cores 112, dielectrics 114, an external conductor layer (shield layer) 116, an outer coat layer (sheath) 118, and a grounding wire (drain wire) 120. In this example, as shown in FIG. 3A, the dielectric 114 surrounds the conductor core 112. The external conductor layer (shield layer) 116 surrounds the dielectrics 114. The outer coat layer (sheath) 118 surrounds the external conductor layer (shield layer) 116.

The conductor core 112 and the grounding wire (drain wire) 120 are formed of a conductive material such as, for example, copper. The external conductor layer (shield layer) 116 can be formed by wrapping metal foil (Al, Cu, or the like) around the dielectric 114. The dielectric 114 is formed of an insulating material such as, for example, a polyethylene system resin and a fluorine system resin. The outer coat layer (sheath) 118 is formed of an insulating material such as, for example, a polyvinyl chloride series resin, a polyethylene system resin, or a fluorine system resin.

As shown in FIG. 2, the coaxial cable 110 can include a first protrusion portion 122 and a second protrusion portion 124 at the end of the coaxial cable 110. In the first protrusion portion 122, the dielectric 114 protrudes from the external conductor layer (shield layer) 116. In the second protrusion portion 124, the conductor core 112 protrudes from the dielectric 114.

As described above, the impedance of the coaxial cable 110 is determined by the inductance and the capacitance per unit length of the cable. As shown in FIG. 3B, in the first protrusion portion 122, the dielectric 114 protrudes from the external conductor layer (shield layer) 116, and the dielectric 114 is covered by air. As shown in FIG. 3C, in the second protrusion portion 124, the conductor core 112 protrudes from the dielectric 114, and the conductor core 112 is covered by air. Therefore, the impedances in the first protrusion portion 122 and the second protrusion portion 124 are different from the impedance of the coaxial cable 110 in a portion in which the circumference of the dielectric 114 is covered by the external conductor layer (shield layer) 116 and the outer coat layer (sheath) 118 as shown in FIG. 3A.

In the substrate unit 100 of the present embodiment, by using the substrate 140 and the shield member 160 described below, it is possible to match impedances more effectively than conventionally known.

Although in the present embodiment an example of two-core coaxial cable is described, a single-core coaxial cable can also be used.

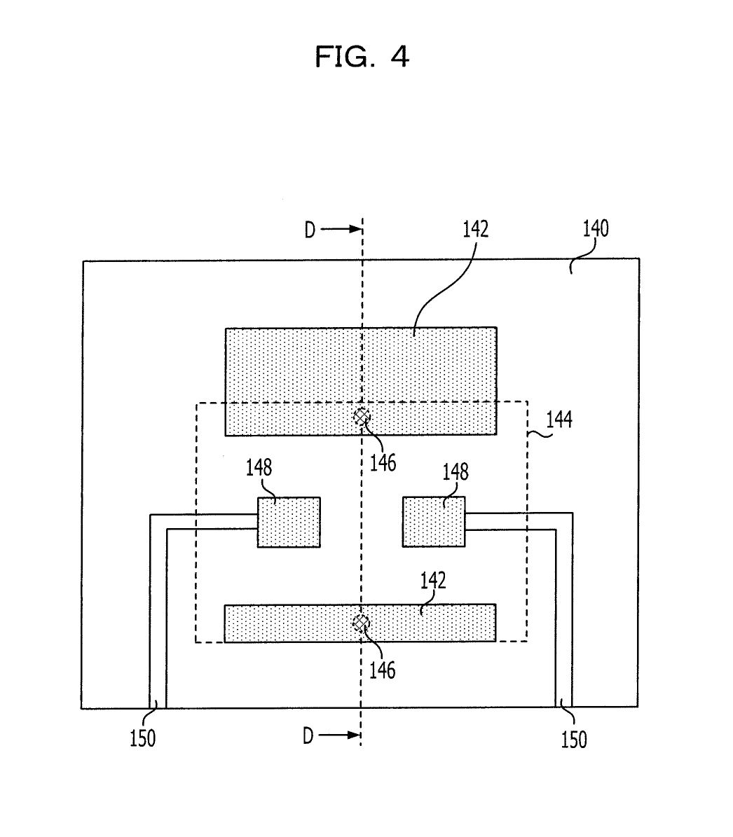

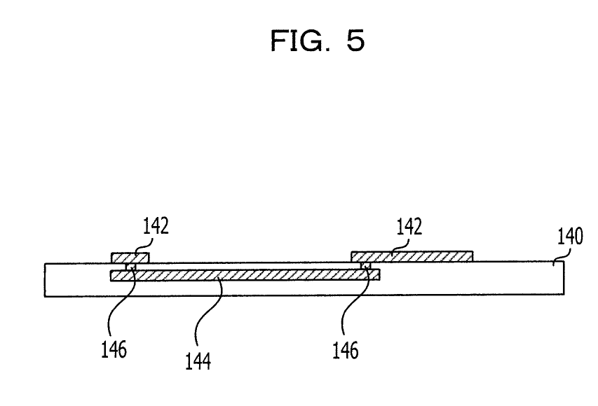

Next, the substrate 140 of the present embodiment will be described with reference to FIGS. 4 and 5. FIG. 4 is a plan view showing an example of the substrate 140 of the present embodiment. FIG. 5 is a cross-sectional view taken along line V-V in FIG. 4. As shown in FIG. 4, the substrate 140 of the present embodiment can include ground electrodes 142, a ground potential layer 144, vias 146, electrodes 148, and signal patterns 150.

The ground electrode 142 is provided on the surface of the substrate 140. The substrate 140 in the example shown in FIG. 4 includes two ground electrodes 142. As described below, the ground electrode 142 is connected to the shield member 160.

The ground potential layer 144 is provided in an inner layer of the substrate 140. Therefore, the ground potential layer 144 is shown by a dashed line in FIG. 4. The ground potential layer 144 is designed as the ground (0 V) of the circuit. The ground potential layer 144 is provided in an area including at least the first protrusion portion 122 and the second protrusion portion 124 of the coaxial cable 110 in a plan view. The ground potential layer 144 is provided so that the ground potential layer 144 overlaps the ground electrodes 142 in a plan view.

The vias 146 are formed in areas where the ground potential layer 144 overlaps the ground electrodes 142 in a plan view. As shown in FIG. 5, the vias 146 electrically connect the ground electrodes 142 with the ground potential layer 144. Therefore, the ground electrodes 142 have a ground potential via the vias 146.

The two conductor cores 112 of the coaxial cable 110 are connected to the electrodes 148. Therefore, the substrate 140 in the example shown in FIG. 4 includes two electrodes 148.

The signal pattern 150 is connected to the electrode 148. In the example shown in FIG. 4, the signal pattern 150 has a shape circumventing the ground electrodes 142 so that the signal pattern 150 is not in contact with the ground electrodes 142. The shape of the signal pattern 150 is not particularly limited, but may be any shape that is not in contact with the ground electrodes 142.

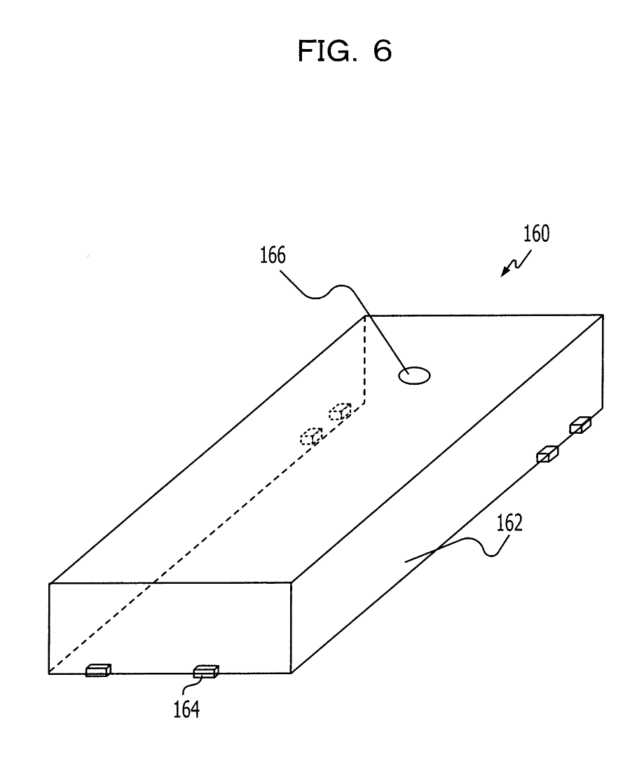

Next, the shield member 160 of the present embodiment will be described with reference to FIG. 6. The shield member 160 includes a housing 162, solder terminals 164, and an opening 166. The housing 162 is formed of a conductive material such as, for example, a tinned brass plate. As shown in FIG. 6, the housing 162 has a rectangular solid shape. As shown in FIG. 1, the shield member 160 is provided to cover the coaxial cable 110 and the substrate 140, so no surface structure is formed at the bottom and the rear of the shield member 160 in FIG. 6.

The solder terminals 164 are provided on the front surface and the side surfaces of the housing 162. In the example shown in FIG. 6, two solder terminals 164 are provided to each of the front surface, the right side surface, and the left side surface of the housing 162. As shown in FIG. 1, the solder terminals 164 are provided to be positioned on the ground electrodes 142. By soldering the solder terminals 164 to the ground electrodes 142, the ground electrodes 142 and the shield member 160 are electrically connected to each other.

The opening 166 is formed in the top surface of the housing 162. As shown in FIG. 1, the opening 166 is an opening for pulling out the grounding wire (drain wire) 120 onto the top surface of the housing 162. The grounding wire (drain wire) 120 pulled out onto the top surface of the housing 162 through the opening 166 is soldered on the top surface of the housing 162.

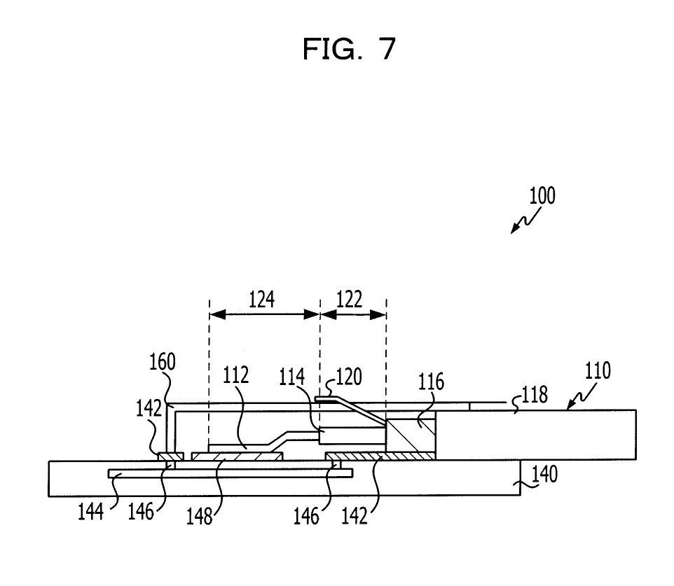

By arranging the coaxial cable 110, the substrate 140, the shield member 160 described above into the form shown FIG. 1, the substrate unit 100 of the present embodiment is formed. Here, the connection relationship between the components included in the substrate unit 100 of the present embodiment will be described with reference to FIG. 7. FIG. 7 is a cross-sectional view taken along a direction in which the conductor core extends in FIG. 1.

As shown in FIG. 7, the shield member 160 is arranged to cover at least the first protrusion portion 122 and the second protrusion portion 124. The grounding wire (drain wire) 120 is connected to the top surface of the shield member 160. The bottom end of the shield member 160 is connected to the ground electrodes 142. The ground electrodes 142 and the ground potential layer 144 are electrically connected to each other via the vias 146 (not shown in FIG. 7). Therefore, the ground potential of the ground potential layer 144, and the potentials of the vias 146, the ground electrodes 142, the shield member 160, the grounding wire (drain wire) 120, and the external conductor layer (shield layer) 116 become the same ground potential. As a result, the space around the first protrusion portion 122 and the second protrusion portion 124 of the coaxial cable 110 is covered with the ground potential, so the impedances of the coaxial cable 110 can be matched better than before.

In addition, the shield member 160 can cover the first protrusion portion 122 and the second protrusion portion 124, so that it is possible to suppress cross-talk and radio noise.

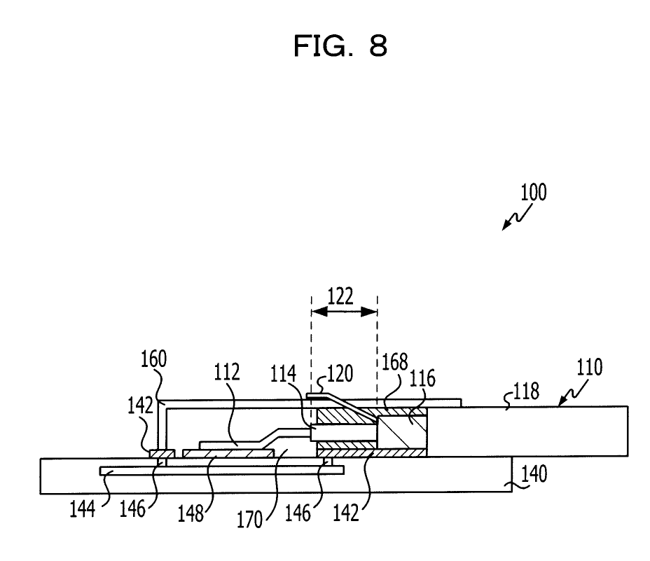

Next, the substrate unit 100 according to a second embodiment will be described. The substrate unit 100 of the second embodiment is different from that of the first embodiment in a point that a conductive material is provided between the first protrusion portion 122 and an inner wall of the shield member 160. The other basic configuration of the substrate unit 100 of the second embodiment is the same as that of the first embodiment described above. Therefore, the description of the same configuration as that of the first embodiment will be omitted. Hereinafter, portions different from the first embodiment will be described with reference to FIG. 8.

FIG. 8 is a cross-sectional view taken along a direction in which the conductor core extends in FIG. 1 according to the second embodiment. As shown in FIG. 8, the substrate unit 100 of the second embodiment includes a conductive material 168 between the first protrusion portion 122 and the inner wall of the shield member 160 in addition to the configuration described in the first embodiment. The conductive material 168 is, for example, a conductive sponge. It is preferred that the conductive material 168 is formed of the same material as that of the external conductor layer (shield layer) 116.

In the substrate unit 100 of the present second embodiment, the dielectric 114 exposed from the external conductor layer (shield layer) 116 in the first protrusion portion 122 is covered with the conductive material 168 instead of air. Therefore, the impedance in the first protrusion portion 122 can be close to the impedance of the portion in which the dielectric 114 is covered with the external conductor layer (shield layer) 116. As a result, it is possible to effectively match the impedances of the coaxial cable 110.

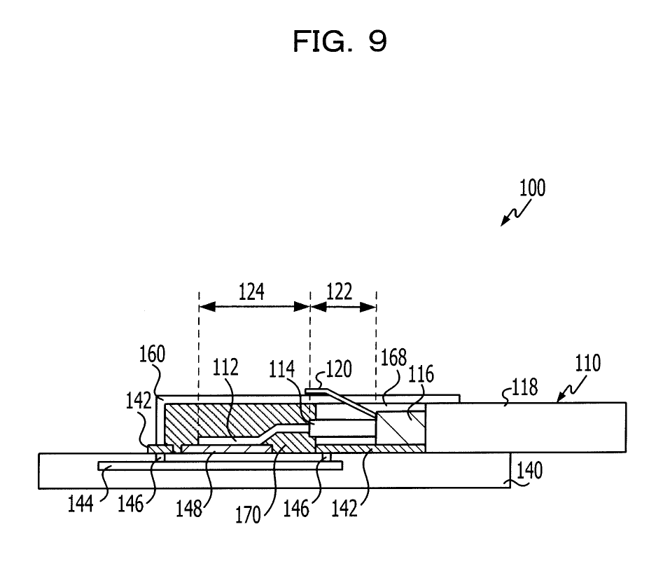

Next, the substrate unit 100 according to a third embodiment will be described. The substrate unit 100 of the third embodiment is different from that of the first embodiment in a point that an insulating material is provided between the second protrusion portion 124 and the inner wall of the shield member 160. The other basic configuration of the substrate unit 100 of the third embodiment is the same as that of the first embodiment described above. Therefore, the description of the same configuration as that of the first embodiment will be omitted. Hereinafter, portions different from the first embodiment will be described with reference to FIG. 9.

FIG. 9 is a cross-sectional view taken along a direction in which the conductor core extends in FIG. 1 according to the third embodiment. As shown in FIG. 9, the substrate unit 100 of the third embodiment includes an insulating material 170 between the second protrusion portion 124 and the inner wall of the shield member 160 in addition to the configuration described in the first embodiment. It is preferred that the insulating material 170 is formed of the same material as that of the dielectric 114.

In the substrate unit 100 of the third embodiment, the conductor core 112 exposed from the dielectric 114 in the second protrusion portion 124 is covered with the insulating material 170 instead of air. Therefore, the impedance in the second protrusion portion 124 can be close to the impedance of the portion in which the conductor core 112 is covered with the dielectric 114. As a result, it is possible to effectively match the impedances of the coaxial cable 110.

In the example shown in FIG. 9, the dielectric 114 exposed from the external conductor layer (shield layer) 116 in the first protrusion portion 122 is covered by air. However, as described in the second embodiment, the dielectric 114 exposed from the external conductor layer (shield layer) 116 in the first protrusion portion 122 may be covered with the conductive material 168. By providing the insulating material 170 between the second protrusion portion 124 and the inner wall of the shield member 160 as well as providing the conductive material 168 between the first protrusion portion 122 and the inner wall of the shield member 160, it is possible to further match the impedances of the coaxial cable 110.

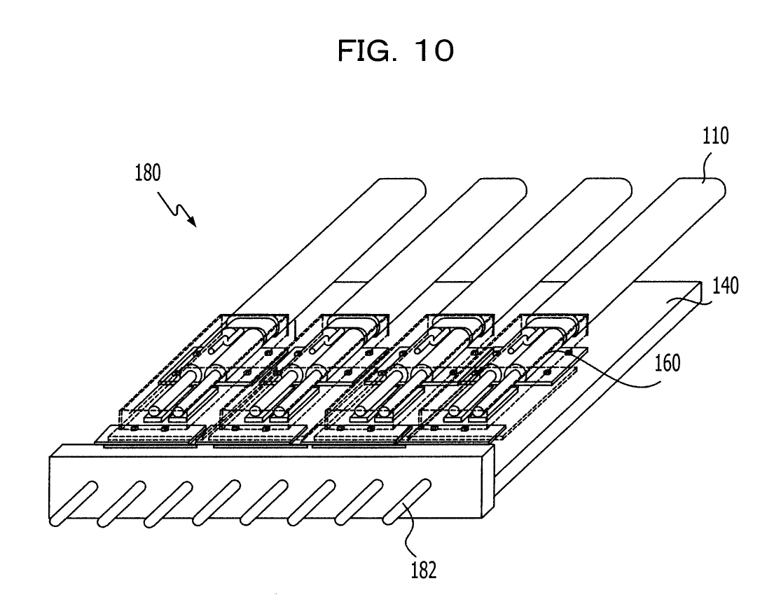

Next, a connector 180 of a fourth embodiment will be described with reference to FIG. 10. FIG. 10 is a perspective view showing an example of the connector of the present embodiment. As shown in FIG. 10, the connector 180 of the fourth embodiment includes the substrate 140, the shield members 160, and contacts 182. The coaxial cables 110 are connected to the connector 180.

The coaxial cable 110, the substrate 140, and the shield member 160 of the fourth embodiment are the same as the coaxial cable 110, the substrate 140, and the shield member 160 described in the first embodiment, so the descriptions thereof will be omitted. As shown in FIG. 10, the contacts 182 are connected to the substrate 140. Although the contact 182 shown in FIG. 10 is a plug type contact, a receptacle type contact may be used.

In the connector 180 of the fourth embodiment, the shield members 160 are arranged to cover at least the first protrusion portion 122 and the second protrusion portion 124. The space around the first protrusion portion 122 and the second protrusion portion 124 of the coaxial cable 110 is covered with the ground potential. Therefore, in the same manner as in the first embodiment, it is possible to effectively match the impedances of the coaxial cable 110.

In the fourth embodiment, in the same manner as in the second embodiment, the conductive material 168 may be provided between the first protrusion portion 122 and the inner wall of the shield member 160. In the fourth embodiment, in the same manner as in the third embodiment, the insulating material 170 may be provided between the second protrusion portion 124 and the inner wall of the shield member 160.

All examples and conditional language recited herein are intended for pedagogical purposes to aid the reader in understanding the invention and the concepts contributed by the inventors to further the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. A terminal structure of coaxial cable, said terminal structure comprising:
a substrate including a ground potential layer therein and a ground electrode thereon configured to electrically connect the ground potential layer through a via;
a coaxial cable including a conductor core, a dielectric body configured to surround the conductor core, an external conductor layer configured to surround the dielectric body, and an outer coat layer configured to surround the external conductor layer, the dielectric body having a first protrusion portion configured to protrude from an end of the external conductor layer, the conductor core having a second protrusion portion configured to protrude from an end of the dielectric body, the second protrusion portion electrically connected to the substrate; and
a conductive shield member configured to cover the first protrusion portion and the second protrusion portion, and configured to be connected to the ground electrode.

2. The terminal structure of coaxial cable according to claim 1, wherein the first protrusion portion and the second protrusion portion are located within the ground potential layer in a plan view.

3. The terminal structure of coaxial cable according to claim 1, further comprising a conductive material provided between the first protrusion portion of the dielectric body and the shield member.

4. The terminal structure of coaxial cable according to claim 1, further comprising an insulating material provided between the second protrusion portion and the shield member.

5. A connector comprising:
a substrate including a ground potential layer therein and a ground electrode thereon configured to electrically connect the ground potential layer through a via;
a coaxial cable including a conductor core, a dielectric body configured to surround the conductor core, an external conductor layer configured to surround the dielectric body, and an outer coat layer configured to surround the external conductor layer, the dielectric body having a first protrusion portion configured to protrude from an end of the external conductor layer, the conductor core having a second protrusion portion configured to protrude from an end of the dielectric body, the second protrusion portion electrically connected to the substrate;
a conductive shield member configured to cover the first protrusion portion and the second protrusion portion, and configured to be connected to the ground electrode; and
a contact configured to be coupled to the substrate.

6. The connector according to claim 5, wherein the first protrusion portion and the second protrusion portion are located within the ground potential layer in a plan view.

7. The connector according to claim 5, further comprising a conductive material provided between the first protrusion portion of the dielectric body and the shield member.

8. The connector according to claim 5, further comprising an insulating material provided between the second protrusion portion and the shield member.

9. A substrate unit comprising:
a substrate including a ground potential layer therein and a ground electrode thereon configured to electrically connect the ground potential layer through a via;
a coaxial cable including a conductor core, a dielectric body configured to surround the conductor core, an external conductor layer configured to surround the dielectric body, and an outer coat layer configured to surround the external conductor layer, the dielectric body having a first protrusion portion configured to protrude from an end of the external conductor layer, the conductor core having a second protrusion portion configured to protrude from an end of the dielectric body, the second protrusion portion electrically connected to the substrate; and
a conductive shield member configured to cover the first protrusion portion and the second protrusion portion, and configured to be connected to the ground electrode.

10. The substrate unit according to claim 9, wherein the first protrusion portion and the second protrusion portion are located within the ground potential layer in a plan view.

11. The substrate unit according to claim 9, further comprising a conductive material disposed between the first protrusion portion of the dielectric body and the shield member.

12. The substrate unit according to claim 9, further comprising an insulating material disposed between the second protrusion portion and the shield member.
